(19) United States
(12) Patent Application Publication
(10) Pub. No.: US 2008/0011503 A1
(43) Pub. Date: Jan. 17, 2008

(54) Universal recessed while-in-use box and cover

(75) Inventor: Cong Thanh Dinh, Collierville, TN (US)

Correspondence Address: HOFFMAN & BARON, LLP, 6900 JERICHO TURNPIKE, SYOSSET, NY, 11791, US

(73) Assignee: Thomas & Betts International, Inc.

(21) Appl. No.: 11/810,116

(22) Filed: Jun. 4, 2007

Related U.S. Application Data
(60) Provisional application No. 60/830,751, filed on Jul. 13, 2006.

(51) Int. Cl. H02G 3/14

(52) U.S. Cl. 174/53

(57) ABSTRACT

A while-in-use recessed electrical outlet box configured with multiple interior bosses, each having one or more mounting opening pairs therein. The mounting opening pairs are positioned such that one pair may be used to secure a single electrical fixture within the box while other mounting opening pairs may be used to secure two electrical fixtures within the box. The mounting opening pairs define a mounting axis such that the outlet box may be mounted with the mounting axis oriented vertically or horizontally. A cover pivots between an open and a closed position, such pivoting being neither parallel to nor perpendicular to the mounting axis.

This application claims priority from provisional application Ser. No. 60/830,751, filed on Jul. 13, 2006, which is incorporated herein in its entirety.

### FIELD OF THE INVENTION

This invention pertains to a recessed electrical outlet box and, more particularly, to a universal recessed while-in-use electrical outlet box, which can be employed in either a horizontal or a vertical orientation and which can be used as either a single or a double-gang box.

### BACKGROUND OF THE INVENTION

Recessed electrical boxes are not new to the art. Such boxes are designed to be recessed in an opening in a wall or building structure so that the actual electrical fixture (duplex, GFCI, switch, data jack, co-axial cable connector, etc.) is recessed into the wall and does not extend beyond the surface of the wall as is normally the case.

Some recessed electrical boxes include covers that can be closed to isolate the interior of the boxes as shown in U.S. Pat. No. 4,988,832 and U.S. Pat. No. 5,171,939. Other recessed boxes include slots in the cover or the frame that permit a wire or electrical cord to pass out of the box even when the cover is closed, see for example U.S. Pat. No. 6,737,576. While these and other recessed box designs are suitable for their intended purpose, they are all configured for installation in either a horizontal position or in a vertical position. They are not designed so that they can be installed in either a vertical position or a horizontal position. Thus, the installer of such boxes needs to maintain a supply of both horizontally oriented and vertically oriented boxes in inventory to ensure that the proper box is available at the job site.

Additionally, these recessed electrical boxes are generally constructed as single gang boxes, although double gang recessed boxes are also used. Consequently, once again, the installer needs to maintain a supply of both types (i.e., single and double gang boxes) in stock. Because of the numerous types of recessed electrical boxes, i.e. horizontal, vertical, single and double gang boxes, a user has to carry a large and diverse inventory of boxes at a substantial cost and utilization of storage space. This is particularly undesirable for a specialty box that is used in only a limited number of applications.

It is thus an object of this invention to provide a recessed electrical outlet box that can be oriented in an opening in a building structure in either a horizontal or a vertical position. Another object of this invention is to provide a box that can be employed as either a single-gang recessed box or a double-gang recessed box. Still another object of this invention is to provide a recessed electrical box that is weatherproof and which is configured to permit an electrical cord to pass out of the box even when the cover is in the closed position. These and other objects and advantages are provided by the recessed box of this invention as set forth in detail in the description and drawings.

### SUMMARY OF THE INVENTION

The present invention relates to a recessed electrical outlet box that includes: (a) a body having a back wall, a face plate, a side wall therebetween and an interior; (b) a plurality of bosses in the body, wherein each boss has at least one mounting hole for mounting at least one electrical fixture intermediate the back wall and face plate; (c) a first pair of mounting holes configured for mounting a single electrical fixture within the recessed electrical outlet box, wherein the first pair of mounting holes defines a first mounting axis; and (d) a second pair of mounting holes and a third pair of mounting holes configured for mounting a pair of electrical fixtures within the recessed electrical outlet box, wherein the second and third pairs of mounting holes define second and third mounting axes, respectively. In a preferred embodiment, the side wall is substantially round so that, when the electrical outlet box is inserted in a circular cut-out in a wall, it can be rotated to orient the mounting axis or axes at any angle.

The recessed electrical outlet box can include a cover pivotally secured to the face plate and movable between an open and a closed position. The cover pivots neither parallel to nor perpendicular to the mounting axes. Instead, the cover pivots on a diagonal axis that is approximately midway between the vertical and horizontal axes. In a preferred embodiment, the face plate is a flange that extends radially outwardly from the side wall and the cover is pivotally attached to the flange. The face plate/flange can have indicia thereon to aid the user in mounting the recessed electrical outlet box in the horizontal or the vertical position.

In another embodiment, the recessed electrical outlet box includes: (a) a body having a back wall, a face plate, a side wall and an interior, wherein the side wall extends from the back wall to the face plate, and wherein the face plate has an opening for accessing the interior; (b) a cover pivotally secured to the face plate and movable between an open position, which allows access to the interior, and a closed position, which prevents access to the interior; (c) one or more pairs of bosses in the interior; (d) a first pair of mounting holes in the one or more pairs of bosses for mounting a single electrical device in the interior, wherein the first pair of mounting holes defines a first mounting axis; and (e) a second pair and a third pair of mounting holes in the one or more pairs of bosses for mounting a pair of electrical devices in the interior, wherein the second and third pairs of mounting holes define second and third mounting axes, respectively. Preferably, the one or more pairs of bosses extend from the back wall and/or the side wall.

The face plate is substantially flat and extends between an outer perimeter and an inner perimeter that defines the opening. The side wall extends between the inner perimeter and the back wall. The face plate can have indicia thereon to aid the user in mounting the recessed electrical outlet box in the horizontal or the vertical position. Preferably, the interior of the outlet box includes a first, a second and a third pair of bosses and the first, second and third pairs of mounting holes are in the first, second and third pairs of bosses, respectively.

For all embodiments of the recessed electrical outlet box, the first, second and third mounting axes can be substantially parallel, or the second and third mounting axes can be substantially parallel and the first mounting axis can be substantially perpendicular to the second and third mounting axes. The recessed electrical outlet box can be mounted so that the mounting axes are oriented either horizontally or vertically. Preferably, the cover has an electrical cord access port, which permits at least one electrical cord to extend out of the interior of the body when the cover is in the closed position. In addition, the cover can be pivotally secured to the face plate by a hinge and releasably secured to the face plate by a latching mechanism when in the closed position. The hinge and the latching mechanism define a latching axis that is neither parallel to nor perpendicular to the first mounting axis. In preferred embodiments, the first mounting axis intersects the latching axis at an angle of between about 30 degrees and about 60 degrees, and more preferably at an angle of about 45 degrees.

### BRIEF DESCRIPTION OF THE DRAWINGS

The preferred embodiments of the universal recessed electrical outlet box and cover of the present invention, as well as other objects, features and advantages of this invention, will be apparent from the following detailed description, which is to be read in conjunction with the accompanying drawings wherein:

FIG. 1 is a top perspective view of a preferred embodiment of the universal recessed electrical outlet box and cover with the cover in the open position thereby providing a view of the interior of the box.

FIG. 2 is a bottom perspective view of a preferred embodiment of the universal recessed electrical outlet box and cover with the cover in the open position.

FIG. 3 is a top view of a preferred embodiment of the universal recessed electrical outlet box and cover with the cover in the open position showing the interior of the box.

FIG. 4 is a side view of a preferred embodiment of the universal recessed electrical outlet box and cover with the cover in the open position.

FIG. 5 is a top perspective view of a preferred embodiment of the universal recessed electrical outlet box and cover with the cover in the closed position.

FIG. 6 is a side view of a preferred embodiment of the universal recessed electrical outlet box and cover with the cover in the closed position.

### DETAILED DESCRIPTION OF PREFERRED EMBODIMENTS

This invention pertains to a recessed electrical outlet box having a body that includes a back wall, a face plate and a side wall extending therebetween that defines an interior. The outlet box also includes a plurality of bosses in the interior of the body, wherein each boss has at least one mounting hole for mounting an electrical fixture intermediate the back and front surfaces. One pair of mounting holes is configured for mounting a single electrical fixture within the interior of the recessed electrical outlet box, while two different pairs of mounting holes are configured for mounting a pair of electrical fixtures within the interior. Each pair of mounting holes defines a mounting axis. The recessed electrical outlet box can be mounted so that the mounting axes can be oriented horizontally or vertically. In addition, the recessed electrical outlet box can include a cover pivotally secured to the body by a hinge and movable between an open and a closed position with respect to the body. This cover is configured to pivot in a direction that is neither parallel to, nor perpendicular, to the mounting axis. The cover pivots along a diagonal axis that is approximately between the vertical axis and the horizontal axis of the box. Preferably, the cover pivots at an angle offset from the mounting axes by from about 30 to about 60 degrees, most preferably about 45 degrees.

The cover is designed so that it pivots diagonally across the opening in the body from either the upper left side to the lower right side or from the upper right side to the lower left side. When the recessed electrical outlet box is installed in a wall with the rear surface of the face plate contacting the wall surface, the closing of the cover is assisted by gravity. This “fail safe” design ensures that the cover will close and cover the front of the outlet box if left unattended. The diagonal closing of the cover also allows the recessed electrical outlet box to be oriented either vertically or horizontally and still provide the same fail safe closing feature.

The recessed electrical outlet box has at least three pairs of mounting holes for mounting electrical fixtures in the interior. These pairs of mounting holes are located in one or more bosses located in the interior. The bosses can extend from the back wall of the outlet box or from the interior surface of the wall or from both the back wall and the interior surface. The bosses are recessed from the face plate so that a plug (or some other type of connecting device) can be connected to an electrical fixture mounted on the bosses and the cover can still be closed. The front of the bosses (i.e., the surface parallel to and closest to the face plate) can extend to about the midpoint between the back wall and face plate. However, the location of the front of the bosses can vary to accommodate different types of electrical fixtures. Preferably, the front of the bosses is located in the middle third of the distance between the back wall and the face plate. The first pair of mounting holes are used when a single electrical fixture is mounted in the outlet box and the second and third pairs of mounting holes are used when two electrical fixtures are mounted in the outlet box. Preferably, the mounting axes for each of the three pairs of mounting holes are parallel to each other. When the outlet box is vertically oriented, the mounting axes are in the vertical direction. Rotating the outlet box by 90 degrees (while maintaining the location of the hinge above the mid-point of the box) orients the outlet box and the mounting axes in the horizontal direction.

The body of the recessed electrical outlet box can have a variety of different shapes, such as oval, rectangular, pentagonal, hexagonal, heptagonal or octagonal, but a round shape is preferred because it is easier to install and offers the maximum flexibility for orienting the outlet box and the fixtures inside the box. In addition, the face plate of the box is preferably in the form of a flange that extends between an inner and outer perimeter. The side wall extends between the back wall and the inner perimeter of the flange. When the outlet box is installed, the wall cutout or opening is sized so that the side wall of the body can pass through the opening and the flange prevents the outlet box from passing through the opening. The rear surface of the flange contacts the wall surface and mounting screws are inserted into one or more mounting openings in the flange to secure the outlet box to the wall. The face plate/flange can also have one or more indicia to assist in orienting the outlet box during installation. For example, the indicia can be a first arrow that points upwardly when the mounting axes of the mounting holes is oriented in the vertical position and a second arrow, about 90 degrees offset from the first, that points upwardly when the mounting axes of the mounting holes is oriented in the horizontal position.

The cover is sized to fit over the opening in the body of the recessed outlet box and can have an opening so that electrical cords or cables can extend into the interior. The electrical box hinge that is used to pivotally open and close the cover and the latch mechanism that is used to secure the cover to the body in the closed position can be selected from any of the conventional hinges and latch mechanisms that are well known to those skilled in the art. The latch mechanism can also include an aperture for inserting a lock. In addition, various seals and gaskets can be used to prevent water from entering the box when the cover is closed and one or more knockouts located in the back and the side wall of the body can be removed to allow electrical wires and cables to enter the interior of the outlet box.

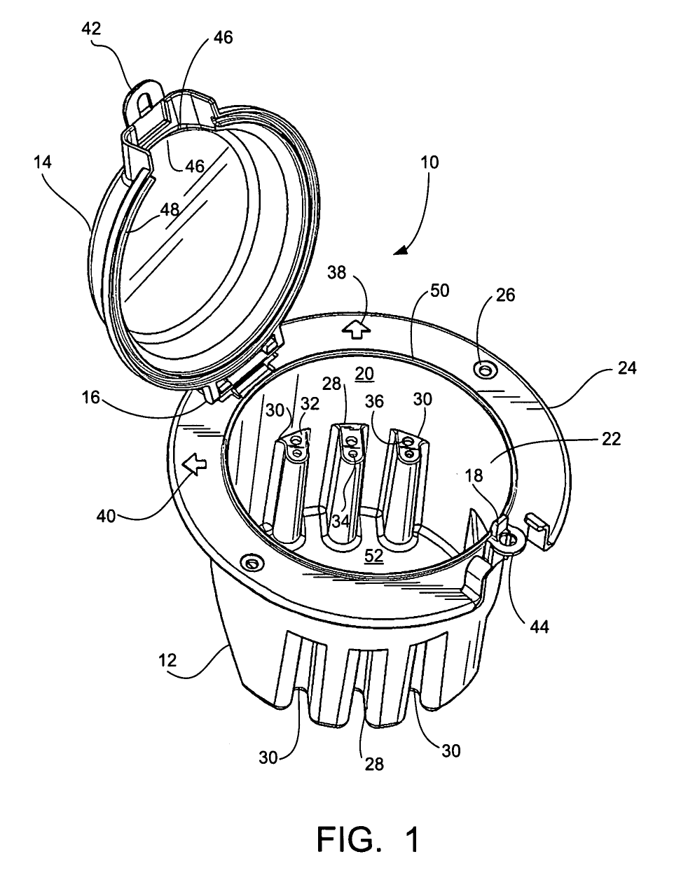

Referring to the drawings, there is shown in FIG. 1 a recessed electrical outlet box 10 that includes a body 12 and a cover 14. The body 12 includes side wall 20 extending between a back wall 52 and a face plate or flange 24 and the cover 14 is pivotally attached to the body 12 by a hinge 16. Opposite the hinge 16 is a latching mechanism 18 that engages a catch 42 on the cover 14 to releasably retain the cover 14 in the closed position. The hinge 16 and the latching mechanism 18 are of a conventional design and components of the hinge 16 and the latching mechanism 18 are, preferably, molded as part of the body 12. Typically, the cover 14 is constructed separately from the body 12 and attached to the body 12 during assembly. Therefore, the preferred design for the hinge 16 is a two component mechanism, wherein the cover 14 attached to the body 12 during the manufacturing process.

The box 10 is typically constructed of a plastic material but other materials can be used. The body 12 and the cover 14 can be made of either the same material or different materials. In preferred embodiments, the cover 14 can be opaque, transparent or translucent, which allows inspection of the interior 22 without opening the cover 14. As shown in FIG. 1, the exterior of the box 10 is preferably round. However, the box 10, or portions of it (including the interior 22 of the body 12), can be rectangular, square, octagon or oval in shape.

The front of the body 12 is formed by a face plate or flange 24, which is substantially flat and extends radially and outwardly from the side wall 20. When the body 12 is inserted into the opening made in a wall structure (not shown), the rear surface of the flange 24 contacts the wall structure and the mounting openings 26 (also referred to herein as mounting screw apertures) can be used to secure the body 12 to the wall structure. In addition, the flange 24 is pivotally connected to the cover 14 by the hinge 16 and the catch 42 on the cover 14 secures the cover 14 to the flange 24 in the closed position by engaging the latching mechanism 18. The catch 42 can be formed as an integral part of the cover 14 or it can be formed separately and attached to the cover 14. Similarly, the latching mechanism 18 can be formed as an integral part of the flange 24 or it can be formed separately and attached to the flange 24. The flange 24 can have one or more mounting openings 26, which are used to secure the body 12, and hence the box 10, to a building structure using a fastener, such as a screw.

The interior 22 of the body 12 is configured with multiple pairs of bosses 28, 30 extending from the back wall 52 and/or the side wall 20. Typically, there are three pairs of bosses 28, 30, the center boss pair 28 and the adjacent outer boss pairs 30, which project into the interior 22 of the body 12. Each end region 32 of each boss of each boss pair 28, 30 is configured with at least one mounting hole 34 therein. Preferably, each boss 28, 30 is configured with at least a mounting holes 34 and a clearance hole 36 in the end region 32.

The mounting holes 34 in the bosses 28, 30 are sized and shaped to accept mounting screws used that are to secure either one or two electrical fixtures (not shown) to the body 12. As used herein, the term “electrical fixtures” includes, but is not limited to any electrical device that can be mounted in an electrical box, such as a duplex receptacle, a GFCI, a switch, a data jack, or a co-axial cable connector. The mounting holes 34 can be pre-threaded for receiving mounting screws therein or the mounting holes 34 can have smooth interior walls, which are threaded (also referred to as “tapped”) by the insertion and rotation of the mounting screws therein. In contrast, the clearance holes 36 are generally sized larger than the mounting holes 34 and, preferably, are not threaded or tapped. The clearance holes 36 provide an opening through which the screws that secure the cover plate (not shown) to the fixture can extend. Hence, while the mounting holes 34 are employed to secure the fixture to the body 12, the clearance holes 36 are employed to provide clearance space for the screws securing the cover plate to the fixture.

In the embodiment shown in the figures, the three boss pairs 28, 30 are located within the interior 22 of the body 12 in accordance with industry guidelines that set forth the requirements, including dimensions, for single and double gang boxes. One having ordinary skill in the art would be familiar with these requirements. The center boss pair 28 is located in accordance with the requirements for a single gang box while the adjacent outer boss pairs 30 are located in accordance with the requirements for a double gang box. Thus, the body 12 provides the user with the option of mounting either a pair of electrical fixtures using the outer boss pairs 30 or, alternatively, mounting a single electrical fixture using the center boss pair 28. Depending on whether the user desires to employ one or a pair of fixtures and depending on the type of fixture or fixtures to be installed, a mating cover plate can then be secured within the body 12 in a conventional fashion so as to seal around the fixture or fixtures in accordance with industry guidelines. Hence, the recessed box 10 can be used as a single or a double gang box. While the boss pairs 28, 30 are shown extending continuously upward from the back wall or bottom 52 of the body 12, other configurations of the boss pairs 28, 30 are equally within the scope of the invention. The boss pairs 28, 30 can extend from the interior side wall 20 intermediate the flange 24 and back wall 52 of the body 12 or only a single boss pair can be used which has multiple mounting holes 34 therein for mounting one or two electrical fixtures.

As shown in FIG. 1, the hinge 16 is positioned on the flange 24 at an angle to the mounting axis of the boss pairs 28, 30. In prior art electrical boxes, the hinge 16 for the cover 14 is positioned at the top of the box 10, whether the mounting axis of the mounting apertures for the electrical devices inside the box 10 is vertical or horizontal. In contrast, the axis for the hinge 16 and the latching mechanism 18 in the present invention is oriented at an angle to the mounting axis of the boss pairs 28, 30, which is approximately 30 to 60 degrees from the horizontal and vertical mounting axis, preferably about 45 degrees. This configuration allows the hinge 16 to use gravity to keep the cover 14 closed, when the box 10 is installed in a wall structure with the mounting axis of the boss pairs 28, 30 oriented either vertically or horizontally. When the body 12 has a round shape and the opening in the wall is substantially round, the body 12 can be freely rotated within the opening so that the mounting axis can be oriented either vertically or horizontally, or any angle in-between the vertical and horizontal axes. Consequently, the box 10 can be used in a variety of applications and its use is not limited by the orientation of the mounting axis of the boss pairs 28, 30.

When the mounting axis of the boss pairs 28, 30 is vertically oriented, the vertical arrow 38 points upwardly and the hinge 16 (as shown in FIG. 1) is to the left of the vertical arrow 38. Similarly, when the mounting axis of the boss pairs 28, 30 is horizontally oriented, the horizontal arrow 40 points upwardly and the hinge 16 (as shown in FIG. 1) is to the right of the horizontal arrow 40. In either case, the cover 14 is above the latching mechanism 18 and gravity assists the closing of the cover 14 so that it contacts the latching mechanism 18. The interior 22 of the body 12 is accessed by uncoupling latching mechanism 18 from the catch 42 on the cover 14, which allows the cover 14 to be pivoted upwardly. Alternatively, a bias (e.g., a spring) can be applied to the cover 14 so that it returns to either the open or closed position when uncoupled or released by the user.

In order for the cover 14 to releasably engage latching mechanism 18, the cover 14 preferably includes a catch 42, which can engage and be disengaged from the latching mechanism 18. A variety of different designs can be used for the latching mechanism 18 and catch 42 design that are well known to those skilled in the art. Some of these designs include a locking ring 44, which has an aperture corresponding to an aperture in the catch 42. After the cover 14 is closed, a lock can be inserted through the two apertures to limit access to the interior 22 of the body 12. The cover 14 and/or the flange 24 can also include an electrical cord (or wire) access port 46 through which one or more electrical cords or wires (not shown) can pass, even when the cover 14 is in the closed position. The cord access port 46, which is preferably located along a lower region of the box 10 near the latching mechanism 18 when the cover 14 is in the closed position, provides weather protection and prevents water from entering the box 10 while it is in use. A gasket (not shown) between the cover 14 and the flange 24 can be used to enhance the weather resistance of the box 10. In a preferred embodiment, this gasket is placed in the groove 48 in the cover 14. The point of contact between the cover 14 and the flange 24 can also be enhanced by a raised rib 50 surrounding the interior 22 of the body 12 along the flange 24.

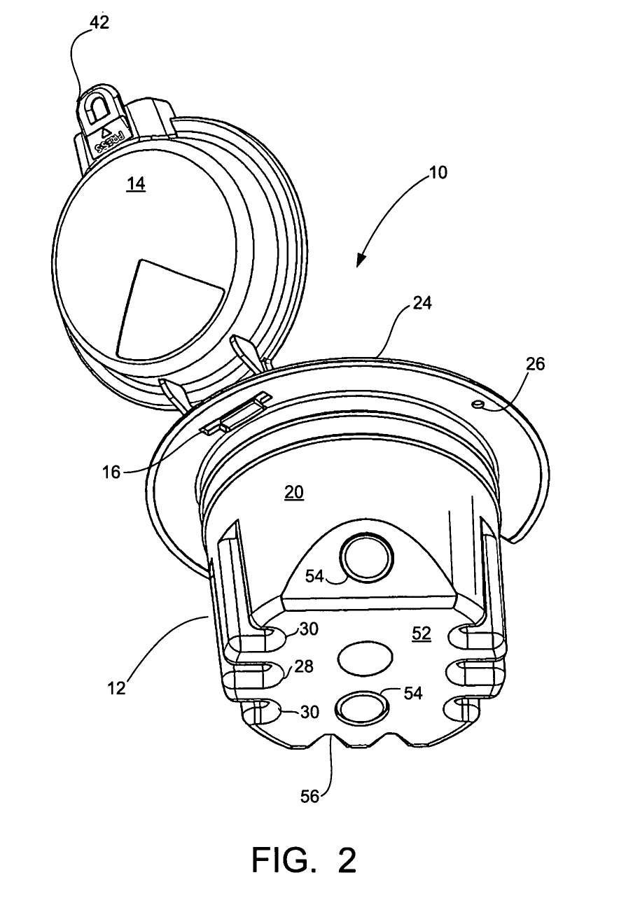

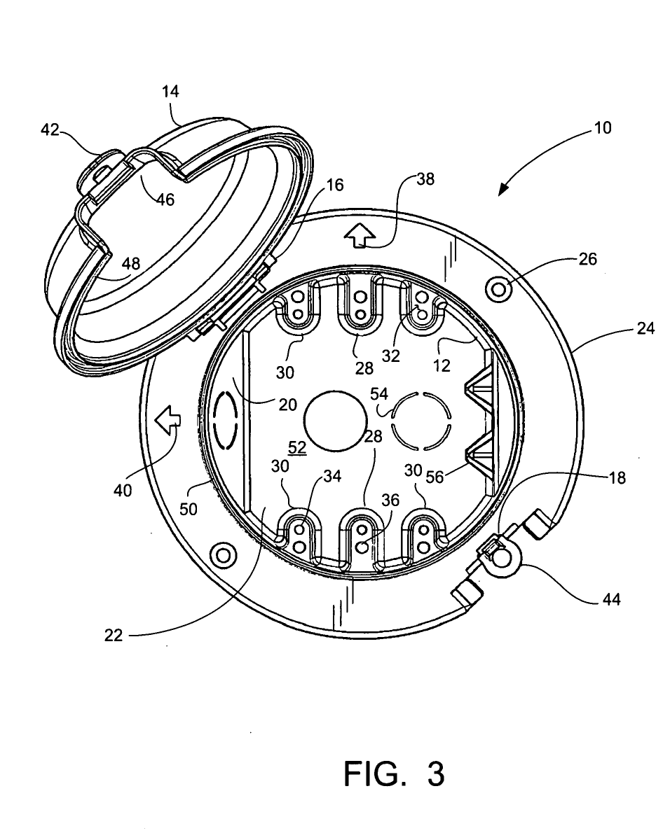

The bottom or back wall 52 of the body 12 can include knockouts 54 or cable entry ports 56 that are commonly used in many electrical boxes. One or more than one of these knockouts 54 and/or cable entry ports 56 can be employed as shown in FIGS. 2 and 3. Power and/or data cables can pass through these entryways 54, 56 and connect to the electrical fixture(s) mounted in the box 10.

While the back wall or bottom 52 of the body 12 is shown as being substantially round or circular, it or portions of it can also be square, oval, rectangular, octagonal or the like. However, a body 12 with a circular shape is preferred, since it is easier to rotate a circular body 12 within a cut-out in the building structure. The circular shape also makes it easier to properly line up either the vertical arrow 38 or the horizontal arrow 40 before the box 10 is secured to the building structure using the mounting openings 26 in the flange 24.

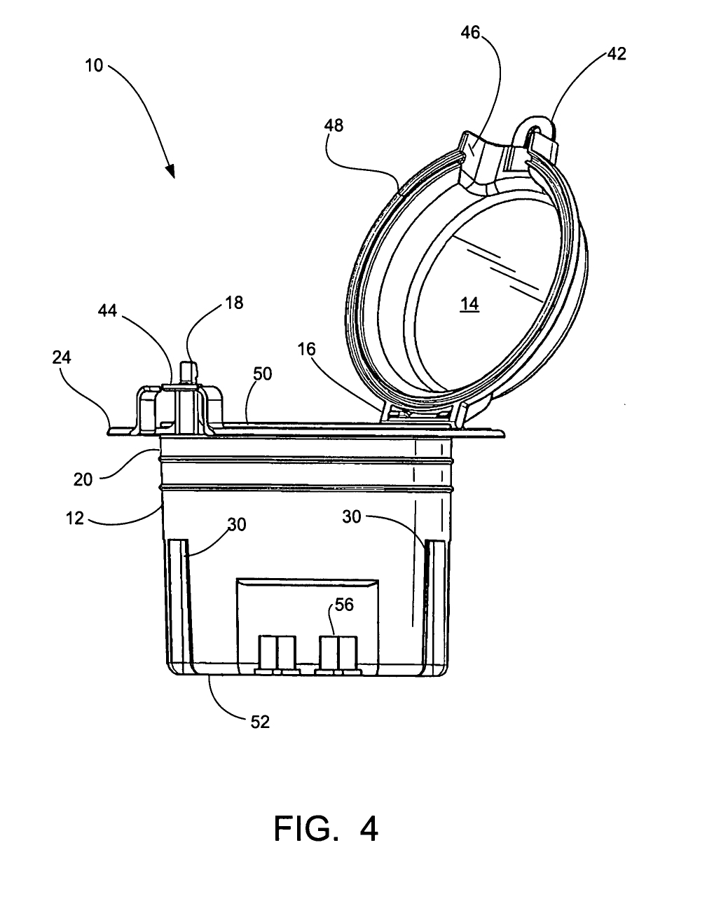

FIG. 4 shows a side view of the box 10 with the cover 14 in the open position. The pairs of bosses 30 and entryways 56 are formed in the side wall 20 of the body 12, preferably as a unitary construction using a molding process. The side view in FIG. 4 illustrates how the face plate/flange 24 extends beyond the side wall 20 so that the bottom surface of the flange 24 contacts the surface around an opening in a wall structure.

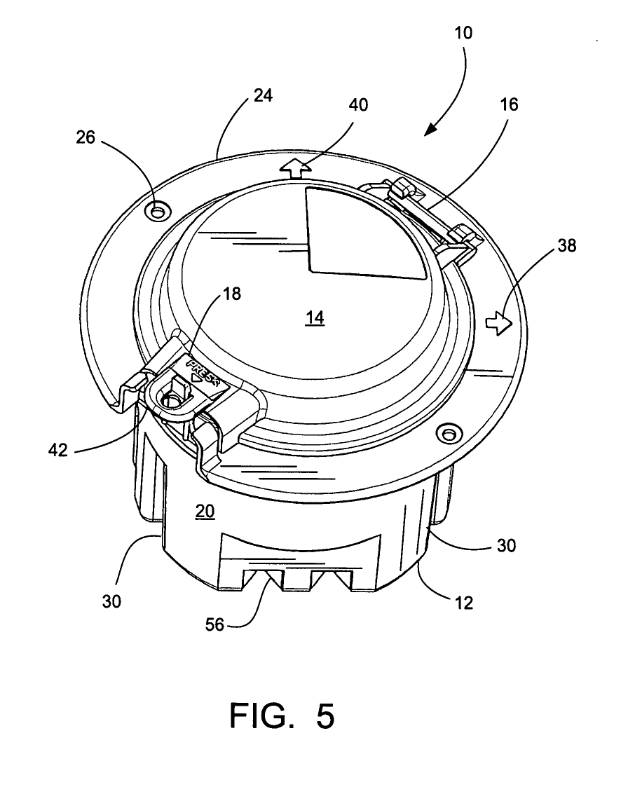

FIG. 5 shows the box 10 with the cover 14 in the closed position. The vertical arrow 38 and the horizontal arrow 40 are used to orient the axis of the electrical device(s) inside the box 10. When the desired orientation of the box 10 is achieved, mounting screws are inserted into the mounting openings 26 to secure the box 10 to a wall structure. The embodiment of the box 10 in FIG. 5 also illustrates a preferred construction of the hinge 16 mechanism, which includes two components. The first component is a clasp that is attached to the flange 24 and the second component is a pin that is attached to the cover 14. The body 12 and the cover 14 are fabricated separately and, during the assembly, the pin of the second component is snapped into the clasp of the first component.

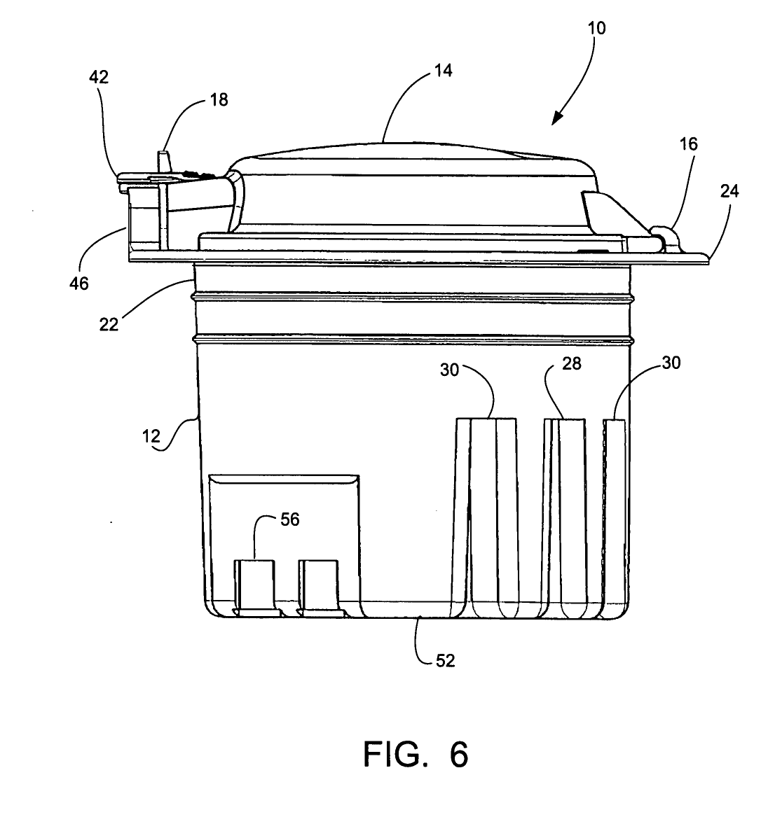

FIG. 6 shows the box 10 with the cover 14 in the closed position and illustrates how the cover 14 is tightly secured to the body 12 by the hinge 16 and the catch 42/latching mechanism 18 combination. The boss pairs 28, 30 and entryways 56 are formed in the side wall 20 of the body 12, preferably as a one piece construction. When the body 12 is formed from a plastic material, any one of a variety of molding methods well known to those skilled in the art can be used to form the body 12 and flange 24 in a single operation.

While select preferred embodiments of this invention have been illustrated, many modifications may occur to those skilled in the art and therefore it is to be understood that these modifications are incorporated within these embodiments as fully as if they were fully illustrated and described herein.

I claim:

1. A recessed electrical outlet box comprising:
(a) a body having a back wall, a face plate, a side wall therebetween and an interior, wherein the faceplate has an opening for accessing the interior;
(b) a plurality of bosses in the interior, wherein each boss has at least one mounting hole for mounting at least one electrical fixture intermediate the back wall and the face plate;
(c) a first pair of mounting holes configured for mounting a single electrical fixture within the interior, wherein the first pair of mounting holes defines a first mounting axis; and
(d) a second pair of mounting holes and a third pair of mounting holes configured for mounting a pair of electrical fixtures within the interior, wherein the second and third pairs of mounting holes define second and third mounting axes, respectively.

2. The recessed electrical outlet box as set forth in claim 1, wherein the first, second and third mounting axes are substantially parallel.

3. The recessed electrical outlet box as set forth in claim 1, wherein the second and third mounting axes are substantially parallel, and wherein the first mounting axis is substantially perpendicular to the second and third mounting axes.

4. The recessed electrical outlet box as set forth in claim 2, wherein the recessed electrical outlet box can be mounted so that the mounting axes are oriented either horizontally or vertically.

5. The recessed electrical outlet box as set forth in claim 4, further comprising a cover pivotally secured to the face plate and movable between an open and a closed position, wherein the cover pivots neither parallel to nor perpendicular to the mounting axes.

6. The recessed electrical outlet box as set forth in claim 5, wherein the cover comprises an electrical cord access port, wherein the electrical cord access port permits at least one electrical cord to extend out of the interior when the cover is in the closed position.

7. The recessed electrical outlet box as set forth in claim 5, further comprising a latching mechanism for releasably securing the cover to the body when the cover is in the closed position.

8. The recessed electrical outlet box as set forth in claim 5, wherein the face plate is a flange extending radially outwardly from the side wall, and wherein the cover is pivotally attached to the flange.

9. The recessed electrical outlet box as set forth in claim 8, wherein the flange has indicia thereon to aid the user in mounting the recessed electrical outlet box in the horizontal or the vertical position.

10. A recessed electrical outlet box comprising:
(a) a body having a back wall, a face plate, a side wall and an interior, wherein the side wall extends from the back wall to the face plate, and wherein the face plate has an opening for accessing the interior;
(b) a cover pivotally secured to the face plate and movable between an open position, which allows access to the interior, and a closed position, which prevents access to the interior;
(c) one or more pairs of bosses in the interior;
(d) a first pair of mounting holes in the one or more pairs of bosses for mounting a single electrical device in the interior, wherein the first pair of mounting holes defines a first mounting axis; and
(e) a second pair and a third pair of mounting holes in the one or more pairs of bosses for mounting a pair of electrical devices in the interior, wherein the second and third pairs of mounting holes define second and third mounting axes, respectively.

11. The recessed electrical outlet box as set forth in claim 10, wherein the first, second and third mounting axes are substantially parallel.

12. The recessed electrical outlet box as set forth in claim 10, wherein the second and third mounting axes are substantially parallel, and wherein the first mounting axis is substantially perpendicular to the second and third mounting axes.

13. The recessed electrical outlet box as set forth in claim 11, wherein the recessed electrical outlet box can be mounted so that the mounting axes are oriented either horizontally or vertically.

14. The recessed electrical outlet box as set forth in claim 11, wherein the cover pivots neither parallel to nor perpendicular to the mounting axes.

15. The recessed electrical outlet box as set forth in claim 11, wherein the cover comprises an electrical cord access port, wherein the electrical cord access port permits at least one electrical cord to extend out of the interior when the cover is in the closed position.

16. The recessed electrical outlet box as set forth in claim 10, further comprising a latching mechanism for releasably securing the cover to the body when the cover is in the closed position.

17. The recessed electrical outlet box according to claim 10, wherein the one or more pairs of bosses extend from the back wall and/or the side wall.

18. The recessed electrical outlet box according to claim 10, wherein the face plate is substantially flat and extends between an outer perimeter and an inner perimeter that defines the opening, and wherein the side wall extends between the inner perimeter and the back wall.

19. The recessed electrical outlet box as set forth in claim 18, wherein the face plate has indicia thereon to aid the user in mounting the recessed electrical outlet box in the horizontal or the vertical position.

20. The recessed electrical outlet box according to claim 10, wherein the interior comprises a first, a second and a third pair of bosses, wherein the first, the second and the third pairs of mounting holes are in the first, the second and the third pairs of bosses, respectively.

21. The recessed electrical outlet box according to claim 10, wherein the cover is pivotally secured to the face plate by a hinge and releasably secured to the face plate by a latching mechanism when in the closed position, wherein the hinge and the latching mechanism define a latching axis that is neither parallel to nor perpendicular to the first mounting axis.

22. The recessed electrical outlet box according to claim 21, wherein the first mounting axis intersects the latching axis at an angle of between about 30 degrees and about 60 degrees.

23. The recessed electrical outlet box according to claim 21, wherein the first mounting axis intersects the latching axis at an angle of about 45 degrees.

24. A recessed electrical outlet box comprising:
(a) a body having a back wall, a face plate, a side wall and an interior, wherein the side wall extends from the back wall to the face plate, and wherein the face plate has an opening for accessing the interior;
(b) a cover pivotally secured to the face plate by a hinge and releasably secured to the face plate by a latching mechanism, wherein the cover is movable between an open position, which allows access to the interior, and a closed position, which prevents access to the interior, wherein the hinge and the latching mechanism define a latching axis;
(c) one or more pairs of bosses in the interior;
(d) a first pair of mounting holes in the one or more pairs of bosses for mounting a single electrical device in the interior, wherein the first pair of mounting holes defines a first mounting axis; and
(e) a second pair and a third pair of mounting holes in the one or more pairs of bosses for mounting a pair of electrical devices in the interior, wherein the second and third pairs of mounting holes define second and third mounting axes, respectively,
wherein the latching axis is neither parallel to nor perpendicular to any of the mounting axes.

25. The recessed electrical outlet box as set forth in claim 24, wherein the first, second and third mounting axes are substantially parallel.

26. The recessed electrical outlet box as set forth in claim 24, wherein the cover comprises an electrical cord access port, wherein the electrical cord access port permits at least one electrical cord to extend out of the interior when the cover is in the closed position.

27. The recessed electrical outlet box according to claim 24, wherein the one or more pairs of bosses extend from the back wall and/or the side wall.

28. The recessed electrical outlet box according to claim 24, wherein the face plate is substantially flat and extends between an outer perimeter and an inner perimeter that defines the opening, and wherein the side wall extends between the inner perimeter and the back wall.

29. The recessed electrical outlet box as set forth in claim 28, wherein the face plate has indicia thereon to aid the user in mounting the recessed electrical outlet box in the horizontal or the vertical position.

30. The recessed electrical outlet box according to claim 24, wherein the first mounting axis intersects the latching axis at an angle of between about 30 degrees and about 60 degrees.

31. A recessed electrical outlet box comprising:
(a) a body having a back wall, a face plate, a substantially round side wall therebetween and an interior, wherein the faceplate has an opening for accessing the interior;
(b) a pair of bosses in the interior, wherein each boss has a mounting hole for mounting an electrical fixture intermediate the back wall and the face plate and wherein the mounting holes define a mounting axis; and
(c) a cover pivotally secured to the face plate and movable between an open and a closed position, wherein the cover pivots neither parallel to nor perpendicular to the mounting axis.
